(19) United States
(12) Patent Application Publication
(10) Pub. No.: US 2018/0082312 A1
(43) Pub. Date: Mar. 22, 2018

(54) Feedback for Vehicle Dealership or Service Providers

(71) Applicant: Ford Global Technologies, LLC, Dearborn, MI (US)

(72) Inventors: Meiyappan Kannappa, Santa Clara, CA (US); Srilaxmi Kanna, San Jose, CA (US); Owen Carpenter, San Francisco, CA (US)

(21) Appl. No.: 15/271,674

(22) Filed: Sep. 21, 2016

(51) Int. Cl. G06Q 30/02

(52) U.S. Cl. CPC G06Q 30/0201

(57) ABSTRACT

A method for obtaining customer feedback includes receiving an indication that a service or sale of a vehicle has been completed. The method includes identifying a customer corresponding to the service or sale and sending a request to the customer for feedback about the service or sale. The method includes associating the feedback with one or more of an automotive dealer, a service advisor, a type of vehicle service performed, or a specific vehicle model corresponding to the service or sale.

### TECHNICAL FIELD

The disclosure relates generally to methods, systems, and apparatuses for obtaining feedback and more particularly relates to quickly obtaining feedback from customers following completion of a sale, service, or other experience with a vehicle dealership or service provider.

### BACKGROUND

Automobiles provide a significant portion of transportation for commercial, government, and private entities. Automobile sales and services constitute a large amount of economic activity and there are a large number of dealers and service providers from which consumers may choose. Because of the expensive and time consuming nature of vehicle purchases and services, as well as the large number of dealers and service providers, customer feedback can be an important way for customers to select a dealer or service provider.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a system for obtaining customer feedback for a vehicle sale or service;

FIG. 2 is a schematic block diagram illustrating a method for obtaining customer feedback, according to one implementation;

FIG. 3 is a schematic block diagram illustrating example components of a feedback system, according to one implementation;

FIG. 4 is a schematic flow chart diagram illustrating a method for obtaining customer feedback, according to one implementation; and

FIG. 5 is a schematic block diagram illustrating a computing system, according to one implementation.

### DETAILED DESCRIPTION

In many in-person sales environments, feedback is collected using paperwork or other offline process (local based computing rather than a web or Internet connected service) and paperwork and is sent to a company headquarters as part of a batch process, and without visibility to consumers. For example, many automotive dealerships and service stations for a specific vehicle make (e.g., authorized dealerships or service stations) provide paperwork to be filled out by a customer or employee and sent to a corresponding automotive manufacturer. Automotive manufacturers and customers often lack a direct channel for obtaining or providing transparent feedback about the experience at a specific dealer or service station.

It will be appreciated that as used herein, the phrases “service provider” and “service station” may be used interchangeably. Additionally, it will be appreciated that a “service provider” may refer broadly to any type of entity or individual that performs a service of any type relating to vehicles, while a “service station” may refer broadly to a location where such services are performed.

In light of the foregoing, applicants have developed systems, methods, and devices for fast, and in some cases real-time, collection of feedback for customer interactions. In some embodiments, paperwork or third-parties are eliminated so that direct and transparent feedback can be obtained and presented to potential customers so that they can make an informed decision about the best dealership or service station for their needs. At least some embodiments are directed to collecting feedback and automatically mapping the source (e.g., customer, dealer, and/or service station) to an owner and/or Vehicle Identification Number (VIN). Specific ratings for a service advisor or other employees may be obtained based on a specific service or purchase performed. Based on a plurality of individual customer ratings an overall rating can be derived for a specific dealer, individual, and/or vehicle make sold/serviced. In one embodiment, feedback may be requested and/or provided via a mobile application (e.g., such as a MyFord® mobile app), website (such as a manufacturer or dealer/service provider website), or via an in-vehicle computer system. An example in-vehicle system to which requests for feedback may be sent and from which feedback may be received include systems such as Ford SYNC®, Android Auto®, and Apple Carplay®.

In one embodiment, after visiting a dealership a notification is sent to a customer's mobile phone, email, or in-vehicle system where they can rate their overall experience and the individual they met with. Ratings and feedback may then be sent to corresponding automotive manufacturers, dealerships, and service stations. Additionally, ratings and feedback may be published to a website, mobile app, or in-vehicle system for viewing by customer. Based on this information, customers can compare dealerships or service stations as well as individual service advisors to insure they get the best possible experience in their area. Thus, customers may be empowered to set their preferred dealership and service advisor based on aggregated data, not just anecdotal experiences. Comments from other customers may also be published so users can understand the ratings better. In one embodiment, users can even search by model to determine how a dealership will service a specific model. For example, some locations may develop a specialty or expert service in a specific type of vehicle.

The present application discloses systems, methods, and devices for requesting, obtaining, and publishing feedback. In one embodiment, a feedback system includes a completion component, a customer component, a request component, and a feedback component. The completion component is configured to receive an indication that a service or sale of a vehicle has been completed. The customer component is configured to identify a customer corresponding to the service or sale. The request component is configured to send a request to the customer for feedback about the service or sale. The feedback component is configured to associate the feedback with one or more of an automotive dealer, a service advisor, a type of vehicle service performed, and a vehicle model corresponding to the service or sale.

In one embodiment, feedback is collected and shared from customers in real-time. Customer purchase and service data related to particular vehicles may be gathered and processed in a manner that is useful to rating dealerships or service stations based on actual customer interactions. This feedback data may provide a detailed factual review, and may automatically be broken down based in specific interactions, specific customers, and specific dealers. Once the information is collected, a vehicle manufacture may use the data take corrective action and prevent future occurrences. Consumers may also benefit as the feedback may be published to allow them to select dealers or preferred dealers through owner touch points including mobile app & websites. Thus, data can be collected at every customer touch point, including purchase points of vehicles, accessories and services, and the customer knowledge information allows the application to rate dealers. In one embodiment, the feedback collection process is triggered when a consumer vehicle is serviced at a dealership and the dealer enters the claim/repair order in a processing system.

Vehicle feedback may be captured in a variety of formats such as text, numerical or star ratings, voice, or the like. In the case of voice feedback, additional information may derived based on intonation or emotion detection. In one embodiment, feedback captured near in time to the occurrence of finishing of a service or sale may provide particular insight into how the customer perceived the interaction. With regard to viewing customer ratings by customers, when a vehicle owner searches for a dealer to set or update as preferred dealer, the search results within an app, in-vehicle system, or website may contain aggregate ratings dealers based on feedback provided by other consumers. In one embodiment, the results may be targeted to a specific vehicle model. For example, a specific dealership may have a rating of 3.5 out of 5 for one service completed for a Ford Mustang® and a rating of 4.75 out of 5 for services completed on Ford Edge® vehicles. This is possible because each consumer will be associated with a VIN and the same can be decoded to identify the vehicle model.

Further embodiments and examples will be discussed in relation to the figures below.

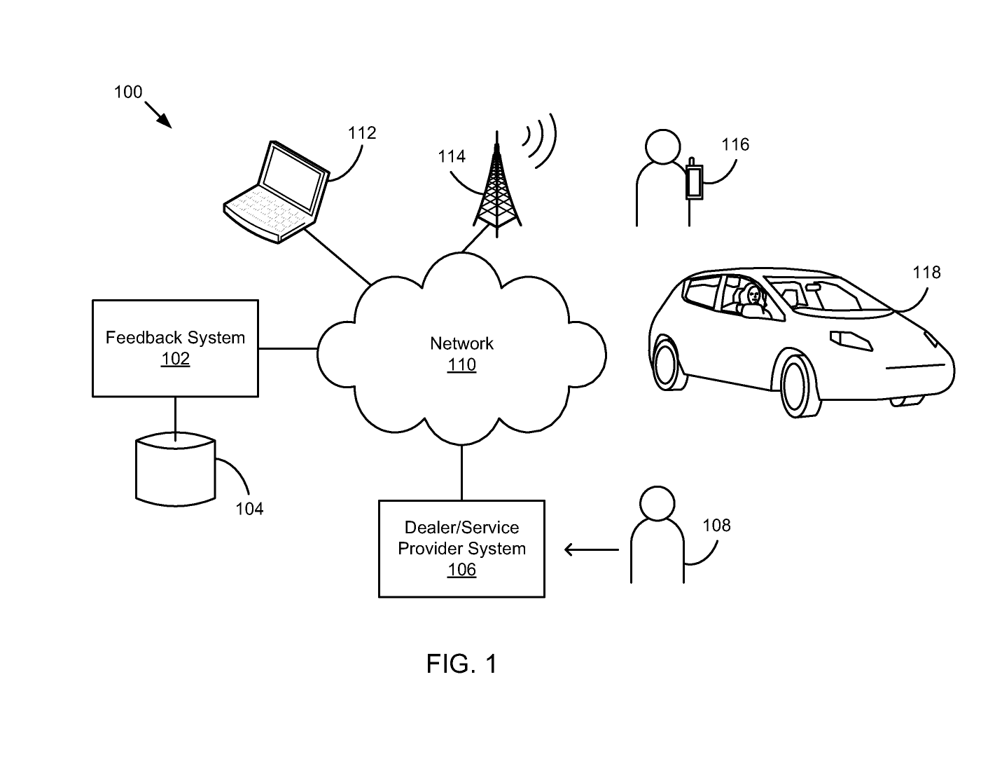

Referring now to the figures, FIG. 1 illustrates a system 100 for obtaining customer feedback. The system 100 includes a feedback system 102 that stores feedback data or other data in data storage 104. The system 100 also includes a dealer/service provider system 106. In one embodiment, an employee 108, such as a salesman or service manager may sell or service a customer vehicle 118 for a customer. Upon completion, or during assistance of the customer, the employee 108 may enter information about the service or sale into the dealer/service provider system 106. For example, a payment transaction, sale transaction, or other transaction may be entered by the employee 108. Based on the completion and/or occurrence of the service or sale, the dealer/service provider system 106 may notify the feedback system 102 of the completion and/or occurrence. In one embodiment, the notification of the service or sale may include a VIN for the vehicle 118, information about a customer, or any other information.

In response to determining that a service or sale has occurred, the feedback system 102 may identify the customer or vehicle 118 and identify a destination address, device, or account corresponding to the customer or vehicle. A request for feedback may be sent to one or more of the destinations to prompt the customer for feedback. For example, the request may be sent to an email address, mobile application on a mobile phone 116 or other mobile device, an in-dash computing system in the vehicle 118, or any other location. In response to the request, the customer may provide feedback using the mobile application on the mobile device 116, a website using a computer system 112, and/or an in-vehicle computing system in the vehicle 118. For example, a mobile device 116 and/or an in-vehicle computing system may be able to communicate using a node 114 of a wireless network 110. In one embodiment, the request for information is sent from the feedback system 102 to a destination in real-time to prompt the user for feedback while the sale or service experience is still fresh.

In response to receiving the request for feedback, the customer may provide text, voice, or other feedback about the sale or service. For example, the user may interface with a touch screen, keyboard, or other input device to indicate a rating or comments for the sale or service. As another example, a computing system (such as the computer system 112, mobile device 116, or an in-vehicle computer) may record and/or process audio feedback spoken by the customer. The feedback may be sent to the feedback system 102 for storage in the data storage 104, further processing, and/or aggregation with other feedback. The feedback system 102 may also publish the data to a vehicle manufacturer, dealership, vehicle service center, customers or the like.

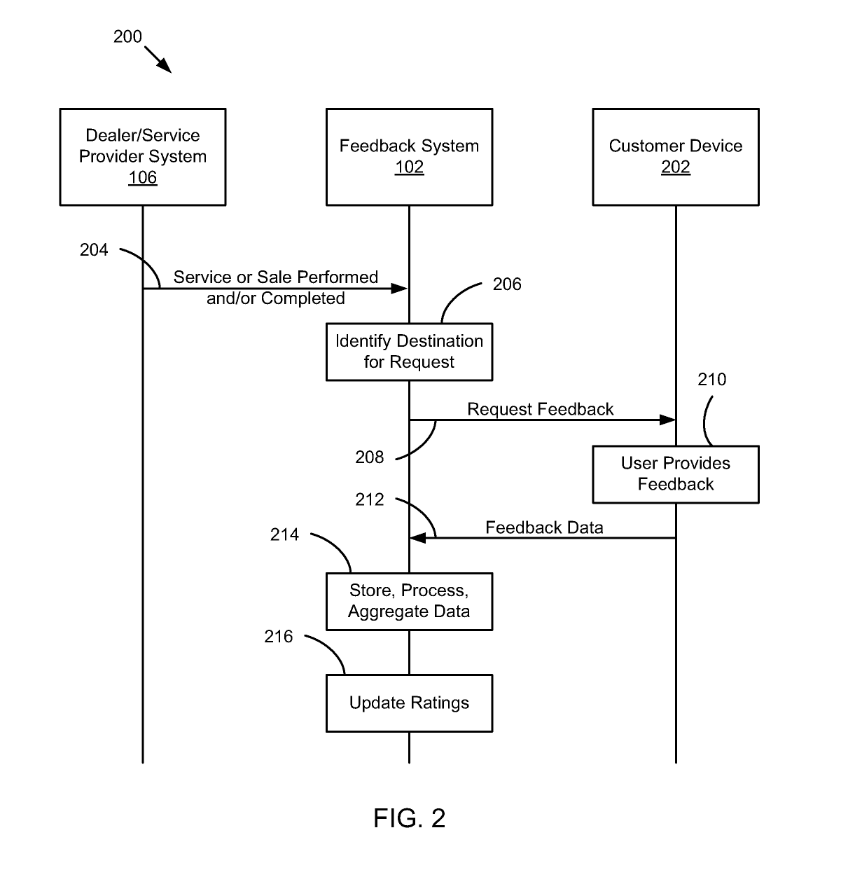

FIG. 2 is a schematic flow chart diagram illustrating a method 200 for gathering feedback. The method 200 illustrates communication between a dealer/service provider system 106, a feedback system 102, and a customer device 202. The customer device 202 may include any device used to access an account, website, or application corresponding to the feedback system 102, such as the computer system 112 or mobile device 116 of FIG. 1 or an in-vehicle computing system. The method 200 may be performed by the system 100 of FIG. 1.

At 204, the dealer/service provider system 106 sends an indication that a service or sale has been performed and/or completed. The indication is received by the feedback system 102. For example, the dealer/service provider system 106 may send a message including details about the service or sale, such as a customer name, VIN for the vehicle which was sold or service, contact information for the customer, or the like. The feedback system 102 identifies at 206 a destination to which to send a feedback request. For example, the feedback system 102 may identify at 206 an account, mobile device, or in-vehicle computing system to which to send a request for feedback.

At 208, the feedback system 102 requests feedback from a customer. For example, the feedback system 102 may send a request to a destination so that the request for feedback arrives at the customer device 202. Using an app on a mobile device, in-vehicle computing system, or other computing device, a user provides at 210 feedback about the sale or service. For example, the user may input text, select a graphical option to indicate a rating, or speak to provide the feedback via the customer device 202. At 212, the feedback is sent by the customer device 202 to the feedback system 102. At 214, the feedback system 102 stores, processes, and/or aggregates the feedback data. For example, the feedback system 102 may clean up comment text, aggregate the feedback data with other feedback, and/or infer intonation or emotion from voice feedback. Based on the feedback, the feedback system 102 updates at 216 ratings for the dealer, service provider, service personnel, salesman, or the like. In one embodiment, the updated rating and/or the feedback data is associated with a specific VIN, customer, vehicle type, dealer, or the like. The updated ratings and/or the feedback data may be published or reported to customers, dealers, or other entities for review so that changes or informed decisions can be made.

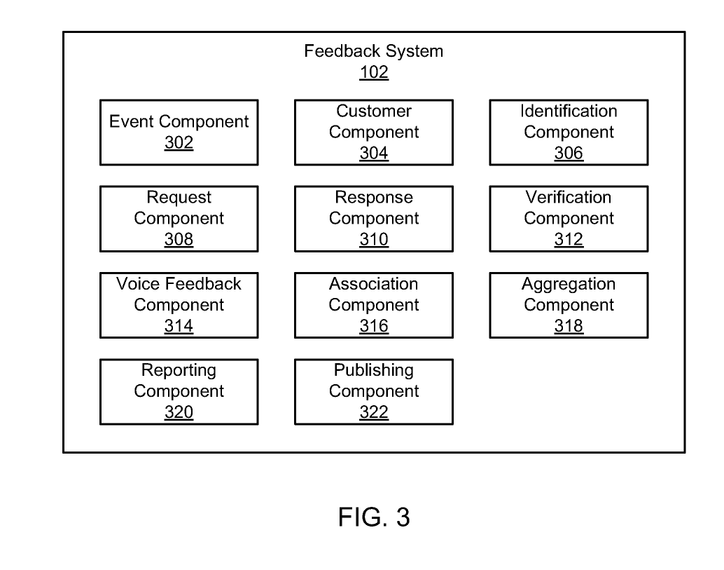

FIG. 3 is a schematic block diagram illustrating example components of a feedback system 102. In the depicted embodiment, the feedback system 102 includes an event component 302, a customer component 304, an identification component 306, a request component 308, a response component 310, a verification component 312, a voice feedback component 314, an association component 316, an aggregation component 318, a reporting component 320, and a publishing component 322. The components 302-322 are given by way of illustration only and may not all be included in all embodiments. In fact, some embodiments may include only one or any combination of two or more of the components 302-322. Some of the components 302-322 may be located outside the feedback system 102 such as within a dealer/service provider system 106 or other system.

The event component 302 is configured to detect the occurrence of a service or sale of a vehicle. In one embodiment, the event component 302 receives an indication that a service or sale of a vehicle has been completed. For example, the event component 302 may receive an indication from a dealer/service provider system 106 that a service or sale of a vehicle has been completed. The dealer/service provider system 106 may include a computing system for an automotive dealer, vehicle service center, or the like. When an employee 108 performs service on a vehicle, or begins assisting a client with a purchase, the employee 108 may enter tracking information, payment information, customer information, or other information about the sale or service into a computing system. The dealer/service provider system 106 may provide an indication about performance of the service to the feedback system 102 for receipt and/or processing by the event component 302. The indication of the occurrence may include details about the specific vehicle, customer, service, dealership, service center. For example, the details may include a VIN, dealership or service center ID, or customer contact information.

The customer component 304 is configured to identify a customer corresponding to the service or sale. The customer component 304 may use information received by the event component 302 to identify a customer that corresponds to a service or sale. The customer component 304 may determine contact information for the customer. For example, the customer component 304 may identify an account, address, or the like corresponding to the customer for sending an email, in-app notification, or in-vehicle notification. In one embodiment, the customer component 304 may look up a VIN, customer name, or the like in a database.

The identification component 306 is configured to identify a vehicle model for the service, sale, or other event. In one embodiment, the identification component 306 may look up a VIN for the vehicle involved in the service or sale in a database to determine the vehicle make, model, year, or any other information about the vehicle. Using the VIN may allow for reducing the amount of information that needs to be stored or transmitted in relation to a transaction.

The request component 308 is configured to send a request to a customer for feedback about the service or sale. The request may include a brief description of the service or sale such as a name of the dealer or service provider, a name of a salesperson, mechanic or customer service representative, and/or details about the model of vehicle. The request may include a form for a user to select options, fill out text fields, or the like. For example, the request may include a star rating where the user can select a star rating for the service or sale. The request component 308 may send the request to an account or location identified by the customer component 304. For example, the request may be sent to an email account, a smart phone application, an in-vehicle computer or the like. In one embodiment, the smart phone application may include an application made available by a vehicle manufacturer that is linked customer account. An in-vehicle computer may receive the request and display a notification in an in-dash display or other location to allow the customer to provide their feedback through the in-vehicle computer.

The request component 308 may send the request in a real-time manner. For example, the request component 308 may send the request to the customer within a threshold time period of the event component 302 identifying the occurrence of an event. In one embodiment, the request component 308 may send the request to the customer within a threshold time period of completion of a service or sale. For example, the request may be sent within a threshold number of seconds or minutes in response the event component 302 determining the occurrence of a sale or service of a vehicle. In one embodiment, a dealer/service provider system 106 may also have constraints requiring reporting of the service or event within a threshold time period of an employee 108 entering data about a sale or service.

In response to receiving the request, the user may provide feedback, comments, recorded voice audio, or any other details about the service or sale. The user may enter the feedback on a mobile device, such as a cell phone, through an in-dash or in-vehicle computing system, and/or using a laptop or desktop computer. In one embodiment, the user may enter the feedback and send it back to the feedback system.

The response component 310 receives the feedback from a user. The response component 310 may receive feedback from the customer through a website, mobile device application, or an in-vehicle computing system. For example, a backend server may receive the data entered or provided by the customer and forward the feedback to the feedback system 102. The response component 310 may store the feedback data in a data store, such as the data storage 104 of FIG. 1. In one embodiment, the feedback may include files, text, audio, or other data provided by the user or user's device.

The verification component 312 is configured to verify information corresponding to the feedback. In one embodiment, the verification component 312 verifies that a specific individual is or has been a customer of a specific dealer, service station, or automobile manufacturer. For example, the verification component 312 may check a separate source, such as a customer list, transaction ledger, or the like to confirm that a customer identified in a source or transaction is actually a customer. In one embodiment, the verification component 312 verifies the occurrence of the service or sale. For example, the verification component may, specific feedback, determine whether the sale or service actually occurred. In one embodiment, the verification component may check a list of service claims or other transactions to confirm that a service or sale corresponding to the feedback was actually performed. The verification component 312 may help verify of validate that the feedback is valid and corresponds to an actual customer and/or transaction. Feedback that is not verified may be omitted from published ratings or comments.

The voice feedback component 314 is configured to process voice feedback within feedback provided by a user or customer. For example, a user may provide feedback by speaking to and/or recording speech using a user device, such as a computing device, mobile device, or in-vehicle computer. The voice feedback component 314 may convert speech to text and process the text to determine a rating, comments, or other feedback data. In one embodiment, the voice feedback component 314 may be located or executed at a user device to limit the amount of data that needs to be transmitted, stored, or processed by the feedback system 102. For example, a mobile application or in-dash computing system may include the voice feedback component 314 and only details derived from the voice feedback, and not a recording of the voice feedback, may be transmitted to the feedback system 102.

In one embodiment, the voice feedback component 314 is configured to perform sentiment analysis on recorded voice or speech. For example, audio recordings of speech often include more data than just the words spoken. The speaker's emotional state, sentiment, or other emotional or physiological condition may be inferred based on intonations, speaking speed, or even the words used. Based on the audio, the voice feedback component 314 may perform sentiment analyses and determined whether the reviewer was happy, excited, angry, or the like. The speaker's emotional state may be determined and recorded. Based on the emotional state, the rating or feedback for a specific dealer, service provider, or other entity or individual may be modified. For example, happy or excited voice intonations may increase the rating for a dealership.

The association component 316 is configured to associate feedback with an individual or entity involved in a corresponding vehicle sale or service. For example, the feedback may be associated with one or more of an automotive dealer, a service advisor, a type of vehicle service performed, and/or a vehicle model corresponding to the service or sale. The association component 316 may associate any portion of feedback or other data determined by the components 302-322 with any entity involved in a sale or service. Thus, the feedback may be used by other parties, such as customers, dealers, vehicle manufacturers, or the like to select a service provider. In one embodiment, the association component 316 stores an indication of the entities to which feedback belongs.

The aggregation component 318 is configured to aggregate feedback from multiple customers. The aggregated feedback may be used to determine an overall rating for a specific entity. For example, a specific employee, dealership, or service station may be assigned a rating based on the aggregated or combined rankings of a plurality of customers. The rating may be expressed as part of a scale, such as a five star rating system. The data may be aggregated into a report for each entity (e.g., dealership, service station, and/or involved employee). For example, the rating and comments for a specific dealership may be combined together into a single table or report.

The reporting component 320 is configured to report the feedback to a dealership, employee, or vehicle manufacturer. For example, the feedback may be provided to a service advisor at a vehicle service center so that the service advisory can know what the customer said and, if applicable, improve or modify how they service customers. Similarly, feedback can be provided to an automotive dealer or vehicle manufacturer to determine a quality of service experienced by customers.

The publishing component 322 is configured to publish feedback or data based on the feedback received from customers. For example, a website, mobile app, or in-vehicle computing system may display the ratings, comments, or other feedback information to a customer to allow the customer to make an informed decision in selecting a dealership or service center. In one embodiment, ratings or other feedback is exposed to customers who have the same vehicle model or vehicle type. For example, if a customer is performing a search for service on a specific vehicle model, the ratings for available service stations may be specific to the vehicle model. Thus, service stations that provide good service for certain types of customers may be able to attract different customers that have the same vehicle model. In-vehicle systems may automatically display service stations corresponding to the vehicle in which the in-vehicle system is located. Because employees may also have ratings, customers may select a specific service advisor to work with in servicing or purchasing a car based on the rating or feedback for that specific service advisor.

In one embodiment, the publishing component 322 allows a user to search feedback based on location, vehicle model, or other data. In one embodiment, the publishing component 322 allows a user to search feedback based not only on location and vehicle model, but also on the type of vehicle service that may be performed, such as brake work, alignment, radiator work and the like. The user may be able to then view the data based on the search and decide where to attempt to purchase or service a vehicle based on the feedback. In one embodiment, the feedback system 102 may act as a web server to provide a website, mobile application, or in-vehicle system backend. For example, when a user accesses the website, mobile application, or in-vehicle system, the publishing component 322 may provide feedback data to the website, mobile application, or in-vehicle system for viewing by the user.

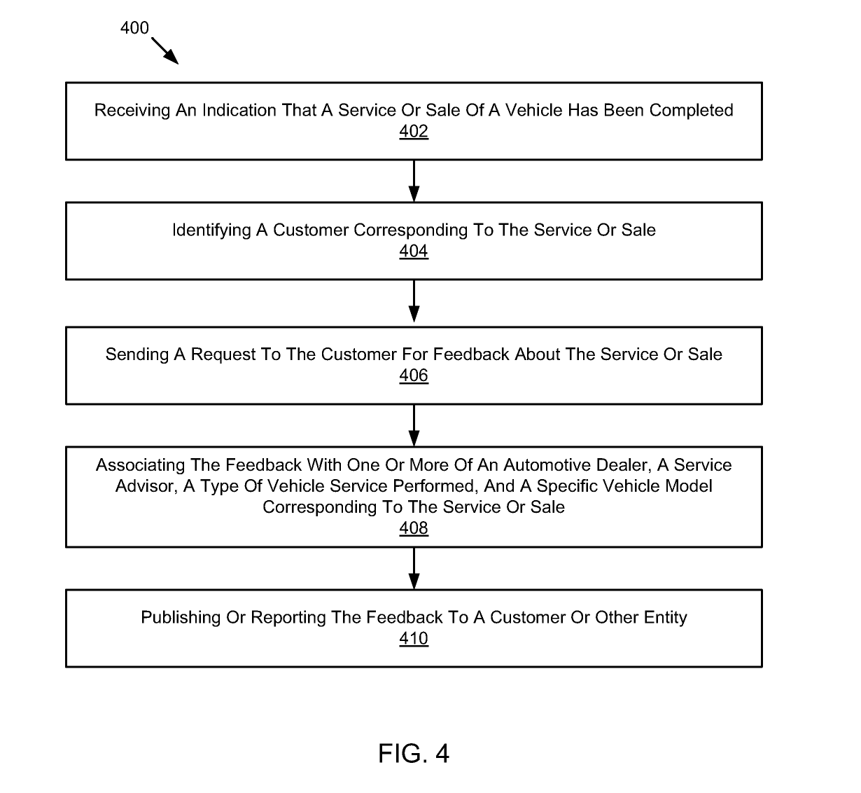

Referring now to FIG. 4, a schematic flow chart diagram of a method 400 for obtaining customer feedback is illustrated. The method 400 may be performed by a feedback system, such as the feedback system 102 of FIG. 1 or FIG. 3.

The method 400 begins and an event component 302 receives at 402 an indication that a service or sale of a vehicle has been completed. A customer component 304 identifies at 404 a customer corresponding to the service or sale. For example, the identification component 306 may identify a customer name, customer account, and/or customer contact information for the customer. A request component 308 sends at 406 a request to the customer for feedback about the service or sale. The request for feedback may be sent to the user via an email address, mobile application account, in-vehicle computing system, or the like. An association component 316 associates at 408 the feedback with one or more of an automotive dealer, a service advisor, a type of vehicle service performed, or a specific vehicle model corresponding to the service or sale. For example, the association component 316 may store an indication the employee or entity the feedback corresponds to. A reporting component 320 or publishing component 322 publishes or reports at 410 the feedback to a customer or other entity. For example, a customer may view the data to identify and/or select a dealership or service provider to use. As another example, a dealership may use the feedback to improve their customer service performance.

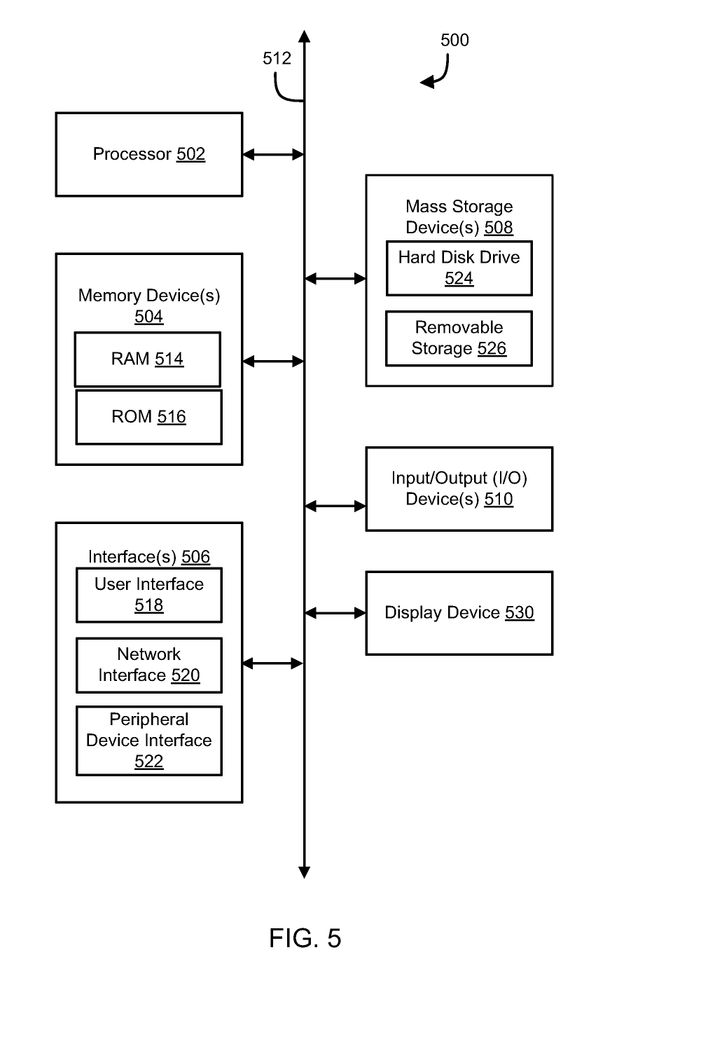

Referring now to FIG. 5, a block diagram of an example computing device 500 is illustrated. Computing device 500 may be used to perform various procedures, such as those discussed herein. Computing device 500 can function as a server, a client, or any other computing entity discussed herein. Computing device 500 can perform various functions such as those discussed in relation to the feedback system as discussed herein, and can execute one or more application programs, such as the application programs or functionality described herein. Computing device 500 can be any of a wide variety of computing devices, such as a desktop computer, a notebook computer, a server computer, a handheld computer, tablet computer, in-dash computer or the like.

Computing device 500 includes one or more processor(s) 502, one or more memory device(s) 504, one or more interface(s) 506, one or more mass storage device(s) 508, one or more Input/Output (I/O) device(s) 510, and a display device 530 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 may include any number of different network interfaces 520, such as interfaces to local area networks (LANs), wide area networks (WANs), wireless networks, and the Internet. Other interface(s) include user interface 518 and peripheral device interface 522. The interface(s) 506 may also include one or more user interface elements 518. The interface(s) 506 may also include one or more peripheral interfaces such as interfaces for printers, pointing devices (mice, track pad, or any suitable user interface now known to those of ordinary skill in the field, or later discovered), keyboards, and the like.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method that includes receiving an indication that a service or sale of a vehicle has been completed. The method includes identifying a customer corresponding to the service or sale and sending a request to the customer for feedback about the service or sale. The method includes associating the feedback with one or more of an automotive dealer, a service advisor, a type of vehicle service performed, or a specific vehicle model corresponding to the service or sale.

In Example 2, the method as in Example 1 further includes identifying vehicle model information based on a VIN corresponding to the vehicle.

In Example 3, the method as in any of Examples 1-2 further includes communicating the feedback information to one or more of a vehicle manufacturer, the automotive dealer, or the service advisor.

In Example 4, the method as in any of Examples 1-3 further includes receiving feedback from the customer through a website, mobile device application, or an in-vehicle computing system.

In Example 5, sending the request to the customer as in any of Examples 1-4 includes sending the request to one or more of a mobile device application or a vehicle in-dash computer.

In Example 6, the method as in any of Examples 1-5 further includes verifying one or more of the customer or the occurrence of the service or sale.

In Example 7, the method as in any of Examples 1-6 further includes aggregating the feedback with other feedback and determining a rating for one or more of the automotive dealer or the service advisor based on aggregated data.

In Example 8, the method as in any of Examples 1-7 further includes publishing feedback or data based on aggregated feedback to customers with a same vehicle model.

Example 9 is a system that includes an event component, a customer component, a request component, and an association component. The event component is configured to receive an indication that a service or sale of a vehicle has been completed. The customer component is configured to identify a customer corresponding to the service or sale. The request component is configured to send a request to the customer for feedback about the service or sale. The association component is configured to associate the feedback with one or more of an automotive dealer, a service advisor, a type of vehicle service performed, or a vehicle model corresponding to the service or sale.

In Example 10, the system as in Example 9 further includes a reporting component configured to communicate the feedback information to one or more of a vehicle manufacturer, the automotive dealer, or the service advisor.

In Example 11, the system as in any of Examples 9-10 further includes a response component configured to receive feedback from the customer through a website, mobile device application, or an in-vehicle computing system.

In Example 12, the request component as in any of Examples 9-11 is configured to send the request to one or more of a mobile device application or a vehicle in-dash computer.

In Example 13, the system as in any of Examples 9-12 further includes a verification component configured to verify one or more of the customer or the occurrence of the service or sale.

In Example 14, the system as in any of Examples 9-13 further includes a publishing component configured to publish feedback or data based on aggregated feedback to customers with a same vehicle model.

Example 15 is computer readable storage media storing instructions that, when executed by one or more processors, cause the processors to receiving an indication that a service or sale of a vehicle has been completed. The instructions further cause the processors to identify a customer corresponding to the service or sale. The instructions further cause the processors to send a request to the customer for feedback about the service or sale. The instructions further cause the processors to associate the feedback with one or more of an automotive dealer, a service advisor, a type of vehicle service performed, or a specific vehicle model corresponding to the service or sale.

In Example 16, the computer readable storage media as in Example 15 further stores instructions that cause the one or more processors to communicate feedback information to one or more of a vehicle manufacturer, the automotive dealer, or the service advisor.

In Example 17, the computer readable storage media as in any of Examples 15-16 further stores instructions that cause the one or more processors to receive feedback from the customer through a website, mobile device application, or an in-vehicle computing system.

In Example 18, instructions as in any of Example 15-17 cause the one or more processors to send the request to the customer by sending the request to one or more of a mobile device application or a vehicle in-dash computer.

In Example 19, the computer readable storage media as in any of Examples 15-18 further stores instructions that cause the one or more processors to aggregate the feedback with other feedback and determining a rating for one or more of the automotive dealer or the service advisor based on aggregated data.

In Example 20, the computer readable storage media as in any of Examples 15-19 further stores instructions that cause the one or more processors to publish feedback or data based on aggregated feedback to customers with a same vehicle model.

Example 21 is a system or device that includes means for implementing a method or realizing a system or apparatus as in any of Examples 1-20.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
receiving an indication that a service or sale of a vehicle has been completed;
identifying a customer corresponding to the service or sale;
sending a request to the customer for feedback about the service or sale; and
associating the feedback with one or more of an automotive dealer, a service advisor, a type of vehicle service performed, or a specific vehicle model corresponding to the service or sale.

2. The method of claim 1, further comprising identifying vehicle model information based on a vehicle identification number (VIN) corresponding to the vehicle.

3. The method of claim 1, further comprising communicating the feedback information to one or more of a vehicle manufacturer, the automotive dealer, or the service advisor.

4. The method of claim 1, further comprising receiving feedback from the customer through a website, mobile device application, or an in-vehicle computing system.

5. The method of claim 1, wherein sending the request to the customer comprises sending the request to one or more of a mobile device application or a vehicle in-dash computer.

6. The method of claim 1, further comprising verifying one or more of the customer or the occurrence of the service or sale.

7. The method of claim 1, further comprising aggregating the feedback with other feedback and determining a rating for one or more of the automotive dealer or the service advisor based on aggregated data.

8. The method of claim 1, further comprising publishing feedback or data based on aggregated feedback to customers with a same vehicle model.

9. A system comprising:
an event component configured to receive an indication that a service or sale of a vehicle has been completed;
a customer component configured to identify a customer corresponding to the service or sale;
a request component configured to send a request to the customer for feedback about the service or sale; and
an association component configured to associate the feedback with one or more of an automotive dealer, a service advisor, a type of vehicle service performed, or a vehicle model corresponding to the service or sale.

10. The system of claim 9, further comprising a reporting component configured to communicate the feedback information to one or more of a vehicle manufacturer, the automotive dealer, or the service advisor.

11. The system of claim 9, further comprising a response component configured to receive feedback from the customer through a website, mobile device application, or an in-vehicle computing system.

12. The system of claim 9, wherein the request component is configured to send the request to one or more of a mobile device application or a vehicle in-dash computer.

13. The system of claim 9, further comprising a verification component configured to verify one or more of the customer or the occurrence of the service or sale.

14. The system of claim 9, further comprising a publishing component configured to publish feedback or data based on aggregated feedback to customers with a same vehicle model.

15. Computer readable storage media storing instructions that, when executed by one or more processors, cause the processors to:
receive an indication that a service or sale of a vehicle has been completed;
identify a customer corresponding to the service or sale;
send a request to the customer for feedback about the service or sale; and
associate the feedback with one or more of an automotive dealer, a service advisor, a type of vehicle service performed, or a specific vehicle model corresponding to the service or sale.

16. The computer readable storage media of claim 15, wherein the media further stores instructions that cause the one or more processors to communicate feedback information to one or more of a vehicle manufacturer, the automotive dealer, or the service advisor.

17. The computer readable storage media of claim 15, wherein the media further stores instructions that cause the one or more processors to receive feedback from the customer through a website, mobile device application, or an in-vehicle computing system.

18. The computer readable storage media of claim 15, wherein instructions cause the one or more processors to send the request to the customer by sending the request to one or more of a mobile device application or a vehicle in-dash computer.

19. The computer readable storage media of claim 15, wherein the media further stores instructions that cause the one or more processors to aggregate the feedback with other feedback and determining a rating for one or more of the automotive dealer or the service advisor based on aggregated data.

20. The computer readable storage media of claim 15, wherein the media further stores instructions that cause the one or more processors to publish feedback or data based on aggregated feedback to customers with a same vehicle model.
